(19) United States
(12) Patent Application Publication
(10) Pub. No.: US 2009/0265364 A1
(43) Pub. Date: Oct. 22, 2009

(54) METHOD AND PROCESS FOR AUTOMATIC GENERATION OF SYMPTOM CODES FROM TEXTUAL PROBLEM DESCRIPTIONS TO ENABLE PROBLEM CLASSIFICATION, EARLY WARNING TREND PREDICTION, AND FAST RECALL OF PROGNOSTIC/DIAGNOSTIC SOLUTIONS

(75) Inventors: Alexander P. Morgan, Birmingham, MI (US); Steven W. Holland, St.Clair, MI (US); Andrea M. Simon, Wolverine Lake, MI (US); Pulak Bandyopadhyay, Bangalore (IN); Sugato Chakrabarty, Bangalore (IN); Rahul Chougule, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/104,010

(22) Filed: Apr. 16, 2008

(51) Int. Cl. G06F 17/30

(52) U.S. Cl. 707/100; 707/E17.005

(57) ABSTRACT

A system and method for converting text related to vehicle service to symptom codes. The method includes typing into work orders and service reports statements that describe the various symptoms and problems of a vehicle that is being serviced. The work orders and service reports are then transmitted to a database facility where they are analyzed. Prior to the reports being analyzed, the text in the work order and service reports is read by a machine reader that converts the text to symptom codes that describe particular vehicle conditions and symptoms. A processor analyzes the codes for patterns and other relationships, and can provide a display of such patterns. Further, the codes and reports are stored in a memory.

### BACKGROUND OF THE INVENTION

1. Field of the Invention

This invention relates generally to a method for assigning symptom codes to textual descriptions in reports generated from vehicle service and, more particularly, to a method for assigning symptom codes to textual descriptions in reports generated from service of a vehicle that are analyzed for patterns and relationships.

2. Discussion of the Related Art

When a vehicle has a mechanical, electrical or other problem, the vehicle owner will typically take the vehicle to a service provider, such as a dealership. At the service location, the vehicle owner will describe to a service advisor the problem that the vehicle is experiencing that needs to be fixed. That description is typically typed into a computer, and may include certain diagnostic or trouble codes associated with vehicle parts or procedures. The description is then printed onto a work order, and the work order is given to a technician who will attempt to fix the problem that has been described. As part of the technician's procedure to fix the vehicle, he will also provide a textual description on a service report as to the problems that he sees with the vehicle, the cause of the problems and the operations that were taken to correct the problem. This information is then typed into a computer by an administrative person.

The work order and the service report may then be transmitted to a central database for a particular vehicle manufacturer who is interested in the types of service that have been performed on their vehicles, especially warranty service. This information is important to the vehicle manufacturer because it can be used to increase vehicle quality and consumer satisfaction. This information is available to engineers and other employees of the vehicle manufacturer that may want to determine why a particular problem is occurring, where the engineer can look at the trouble codes and read the text provided by both the service advisor and the technician.

Currently, about 80% of the information on these types of service reports is textual. The most vital diagnostic information is often captured in the text, but the text is difficult to use for decision support activities for various reasons, such as the text being ungrammatical. Available methods for capturing knowledge from text do not work quickly or accurately enough for an early warning or problem solving environment. However, the large amount of diagnostic relevant information, such as repair logs, manufacturing process control documents, launch diaries, etc., can greatly assist in identifying problems before they become overly serious.

### SUMMARY OF THE INVENTION

In accordance with the teachings of the present invention, a system and method is disclosed for converting text related to vehicle service to symptom codes. The method includes typing into work orders and service reports statements that describe the various symptoms and problems of a vehicle that is being serviced. The work orders and service reports are then transmitted to a database facility where they are analyzed. Prior to the reports being analyzed, the text in the work order and service reports is read by a machine reader that converts the text to symptom codes that describe particular vehicle conditions and symptoms. A processor analyzes the codes for patterns and other relationships, and can provide a display of such patterns. Further, the codes and reports are stored in a memory.

Additional features of the present invention will become apparent from the following description and appended claims, taken in conjunction with the accompanying drawings.

### BRIEF DESCRIPTION OF THE DRAWINGS

FIG. 1 is a plan view of a system for converting text in a vehicle service report to symptom codes, according to an embodiment of the present invention; and

FIG. 2 is a flow chart diagram showing a process for converting vehicle service text to symptom codes, according to an embodiment of the present invention.

### DETAILED DESCRIPTION OF THE EMBODIMENTS

The following discussion of the embodiments of the invention directed to a system and method for converting the text in vehicle service reports to symptom codes is merely exemplary in nature, and is in no way intended to limit the invention or its applications or uses.

As discussed above, the text in the various service reports that are provided by a vehicle service center to a database facility operated by a vehicle manufacturer can only be accessed by persons that actually read the text. The present invention proposes a system and method for converting that text to symptom codes that can then be analyzed by a processor in combination with other diagnostic trouble codes to identify problem areas as quickly as possible. Focusing on symptom descriptions, such as customer complaints, allows a meaningful template for information extraction, overcoming difficulties of ungrammatical text and the ambiguity of general text.

To be useful for decision support, the text data should be mapped to a set of features that ideally have only a finite number of known values. This mapping process can be referred to as information extraction. One characteristic of this type of mapping is that it disambiguates the text by focusing its information into certain restricted channels of maximum interest. There are many possible elements of the disambiguation process. For example, the use of domain-specific knowledge is a key feature of the process. Prognostics/diagnostics text in the automotive industry has a typical structure, and in particular the symptoms given in customer complaints are described according to certain typical formats. For example, many symptoms have the format “part inoperative.” It turns out that identifying part name categories referenced in the text is a core challenge. Part names can be recognized and classified using unique technologies that exploit existing protocols to mimic the leverage of ontologies and use the power of entropy estimates to pick up the most likely interpretations. The part name classification problem is the most difficult part of the process. The other symptoms can be classified using similar ideas. The classification process identifies nodes in the ontologies that most disambiguates the symptom references. These nodes can be used to provide smart indexes for the text, and enable the applications noted.

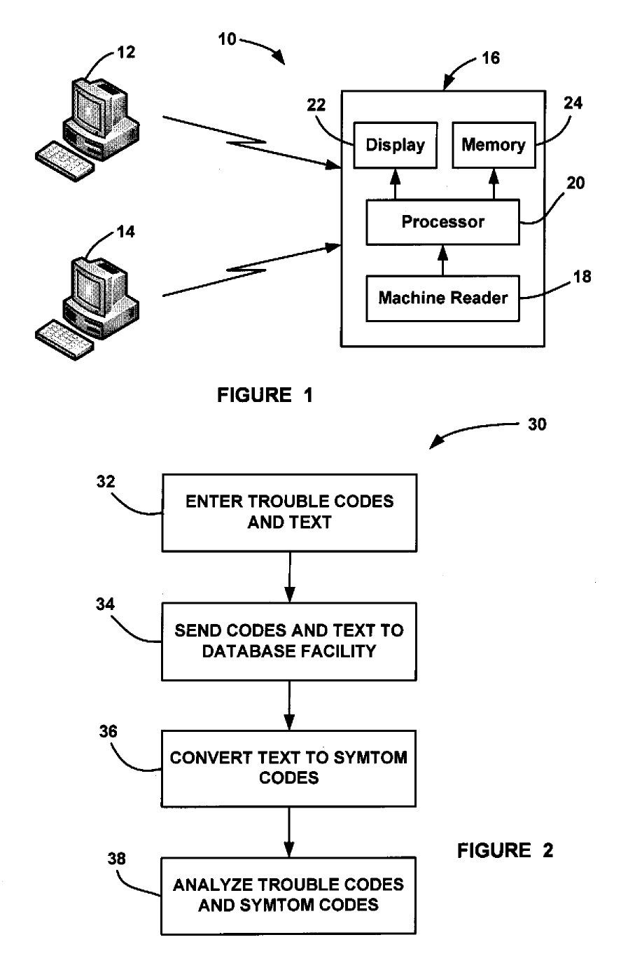

FIG. 1 is a plan view of a data retrieval system 10 that can be used to illustrate the concept of the invention discussed above. Computers 12 and 14 represent the computers at different service facilities, such as dealerships, around the world where a particular vehicle service procedure is performed, such as a vehicle warranty procedure. A service personal, technician, administrative assistant, etc. may enter information using the computers 12 and 14 relating to the particular service procedure being performed on a vehicle. Those various reports, logs, work orders, etc. that are being typed into the computers 12 and 14 typically include a significant amount of text that has information that was told to the service personal by the vehicle owner describing the problems and symptoms of the vehicle, and the particular action taken by a technician working on the vehicle, including possible causes of the particular problem. The various reports are not limited to a particular format, but can be in any suitable format where information concerning vehicle service is applicable.

The information that is put into the computers 12 and 14 is transmitted or sent by some suitable process to a database facility 16 that receives such reports from many service facilities. The particular reports are sent to a machine reading processor 18 that has been programmed to convert the text in the documents provided in by the service personal and technicians to a particular symptom code depending on the text. For example, a particular problem being serviced might be steering wheel pulls to the left. Machine readers that read text are well known to those skilled in the art. The machine reading processor 18 would be programmed with a code for that symptom so that the text is converted to a decipherable context. Thus, the various diagnostic trouble codes and symptom codes in the reports are now provided as computer readable codes, and can be analyzed by a processor 20. The processor 20 can display the codes on a display 22 and can analyze the codes to identify various patterns and relationships between the codes that might be of interest. Further, the codes are stored in a memory 24.

FIG. 2 is a flow chart diagram 30 showing the process of the invention as discussed above. At box 32, various service personal and technicians enter diagnostic trouble codes and related text in a suitable report into the computers 12 and 14. These reports are then sent to the recording facility 16 at box 34. The machine reading processor 18 converts the text to symptom codes at box 36. The diagnostic trouble codes and the symptom codes are then analyzed by the processor 20 at box 38 to look for relationships indicating a problem with a particular vehicle.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for documenting vehicle service procedures, said method comprising:
entering text into a report that describes a particular problem with a vehicle;
transferring the report to a database facility;
converting the text in the report to one or more symptom codes in the database facility; and
analyzing the symptom codes to determine whether a problem exists over a population of vehicles.

2. The method according to claim 1 wherein converting the text includes using a machine reader.

3. The method according to claim 1 further comprising entering diagnostic trouble codes into the report and wherein analyzing the symptom codes includes analyzing the combination of the trouble codes and the symptom codes.

4. The method according to claim 1 wherein transferring the report to a database facility includes transferring reports from many service locations to the database facility.

5. The method according to claim 1 wherein entering text into a report includes entering text into a report described by a user of a vehicle and by a technician who services the vehicle.

6. The method according to claim 1 further comprising storing the symptom codes at the database facility.

7. The method according to claim 1 wherein analyzing the codes includes looking for patterns and relationships in the symptom codes.

8. The method according to claim 1 further comprising displaying the symptom codes on a display.

9. The method according to claim 1 further comprising assigning predetermined symptom codes to predetermined textual descriptions of the vehicle.

10. A method for documenting vehicle service procedures, said method comprising:
entering text into reports that describe problems with a vehicle that includes reports for information described by a user of a vehicle and by a technician who services the vehicle;
transferring the reports to a database facility;
converting the text in the report to one or more symptom codes in the database facility using a machine reader; and
analyzing the codes to look for relationships and patterns.

11. The method according to claim 10 further comprising entering diagnostic trouble codes into the report and wherein analyzing the codes includes analyzing the combination of the trouble codes and the symptom codes.

12. The method according to claim 10 wherein transferring the report to a database facility includes transferring reports from many service locations to the database facility.

13. The method according to claim 10 further comprising storing the symptom codes at the database facility.

14. The method according to claim 10 further comprising assigning predetermined symptom codes to predetermined textual descriptions of the vehicle.

15. The method according to claim 10 further comprising displaying the symptom codes on a display.

16. A method for documenting vehicle service procedures, said method comprising:
assigning predetermined symptom codes to predetermined textual descriptions of the vehicle;
entering text into a report that describes a particular problem with a vehicle, wherein entering text into a report includes entering text into a report described by a user of a vehicle and by a technician who services the vehicle;
entering diagnostic trouble codes into the report;
transferring the report to a database facility;
converting the text in the report to one or more symptom codes in the database facility, wherein converting the text includes using a machine reader; and
analyzing the symptom codes to determine whether a problem exists over a population of vehicles, wherein analyzing the symptom codes includes analyzing the combination of the trouble codes and the symptom codes, and wherein analyzing the codes includes looking for patterns and relationships in the codes.

17. The method according to claim 16 wherein transferring the report to a database facility includes transferring reports from many service locations to the database facility.

18. The method according to claim 16 further comprising displaying the symptom codes on a display.

19. The method according to claim 19 further comprising storing the symptom codes at the database facility.
